(19) United States
(12) Patent Application Publication
(10) Pub. No.: US 2018/0264474 A1
(43) Pub. Date: Sep. 20, 2018

(54) Folded Multi-Material Microfluidic Devices for Tissue Engineering

(71) Applicants: Northeastern University, Boston, MA (US); San Jose State University Research Foundation, San Jose, CA (US); Robert Lang, Alamo, CA (US)

(72) Inventors: Carol Livermore, Framingham, MA (US); Tian Liu, Somerville, MA (US); Robert Lang, Alamo, CA (US); Xin Xie, Everett, MA (US); Roger Alperin, Carlsbad, CA (US)

(21) Appl. No.: 15/922,447

(22) Filed: Mar. 15, 2018

Related U.S. Application Data
(60) Provisional application No. 62/471,532, filed on Mar. 15, 2017.

(51) Int. Cl. B01L 3/00; C08G 77/04

(52) U.S. Cl. CPC B01L 3/502776; B01L 3/502715; C08G 77/04; B01L 2300/0874; B01L 2300/161; B01L 2300/087; B01L 2300/0893; B01L 3/502746; B01L 2300/14; B01L 2300/0864

(57) ABSTRACT

Described herein are multi-material, multi-functional microfluidic devices comprising a folded architecture that mimics the layered arrangement of cells in certain tissues. The devices are suitable for tissue engineering (for example, for drug screening or implants), biological sensing, or diagnostics. The complex, three-dimensional devices may be fabricated without the use of alignment tooling.

### RELATED APPLICATION

This application claims the benefit of priority to U.S. Patent Application Ser. No. 62/471,532, filed Mar. 15, 2017.

### GOVERNMENT SUPPORT

This invention was made with government support under Grant No. 1332249 from the National Science Foundation and the Air Force Office of Scientific Research. The government has certain rights in the invention.

### BACKGROUND

Specific types of biological tissue have specific functions that are enabled by their structures. Tissue functions can include transport of nutrients into a tissue or byproducts out of a tissue, metabolic function, load bearing, actuation, transmission of nervous system stimuli, and more. Tissue structure includes the types of cells and other materials that are included in the tissue, as well as the organization of these elements with respect to each other. Some of a tissue's structural features are at small length scales, such as the scale of individual cells and extracellular matrix. Other features are at larger length scales, such as vasculature and the quasi-layered organization of cells in skin, bone, and cartilage. In general, tissues function properly because the proper elements (e.g., cells and extracellular matrix (ECM)) interact with each other in the ways that the tissues, organs, and the organism require.

An illustrative example of biological tissue having a function that is enabled by its structure is liver tissue. Liver tissue comprises repeating functional subunits called liver lobules. Each liver lobule carries out the array of typical liver functions, including synthesizing proteins such as albumin for sustaining osmotic pressure in the circulatory system, metabolizing drugs and other chemicals, filtering the blood, and secreting bile. In part, these functions are made possible by the types of cells that are included in the liver lobules, with hepatocytes synthesizing proteins and metabolizing drugs, and with endothelial cells forming the vasculature (called sinusoids) through which the blood flows in order to be filtered in the liver. The functions are also made possible by the orientation and arrangement of the cells with respect to each other. For example, blood flows through the narrow liver sinusoids, which are primarily walled with endothelial cells. The endothelial cells are fenestrated (i.e., they contain pores). The fenestrations are too small to permit pressure-driven flow from the interior of the sinusoids into the sheets of hepatocytes that lie outside the sinusoids. The ECM that primarily occupies the space between the endothelial cells and the hepatocytes (the Space of Disse) also prevents direct flow from the interior of the sinusoids to the hepatocytes outside of the sinusoids. However, transport of species between the blood flow (inside the sinusoids) and the hepatocytes (outside the sinusoids) does take place. This transport takes place by diffusion across the fenestrated endothelium and across the Space of Disse; nutrients diffuse to the hepatocytes, and the hepatocytes' products diffuse back to the sinusoids.

### SUMMARY

In certain embodiments, the invention relates to a device comprising a first sheet and a second sheet folded in an interlocking pattern, thereby forming a stack of co-folded layers; wherein
the second sheet is nanoporous;
the first sheet comprises
   a first pattern of first holes comprising a central hole and four first flow holes, wherein at least two of the first flow holes are operably connected to the central hole, and
   a second pattern of first holes comprising a central hole and four first flow holes, wherein at least two of the first flow holes are operably connected to the central hole,
the second sheet comprises a repeating pattern of four second flow holes;
the four first flow holes in the first pattern align with the four first flow holes in the second pattern, and the four first flow holes in the first pattern and in the second pattern align with the four second flow holes;
the central hole in the first pattern aligns with the central hole in the second pattern;
the second sheet is disposed between the first pattern and the second pattern; and
the first flow holes that are operably connected to the central hole in the first pattern do not align with the first flow holes that are operably connected to the central hole in the second pattern, thereby defining a first flow path and a second flow path that are independent from each other.

In certain embodiments, the invention relates to a method of making a device comprising a first sheet and a second sheet, comprising the step of:
folding in an interlocking pattern the first sheet and the second sheet, thereby forming a stack of co-folded layers,
wherein
the second sheet is nanoporous;
the first sheet comprises
   a first pattern of first holes comprising a central hole and four first flow holes, wherein at least two of the first flow holes are operably connected to the central hole, and
   a second pattern of first holes comprising a central hole and four first flow holes, wherein at least two of the first flow holes are operably connected to the central hole,
the second sheet comprises a repeating pattern of four second flow holes;
the four first flow holes in the first pattern align with the four first flow holes in the second pattern, and the four first flow holes in the first pattern and in the second pattern align with the four second flow holes;
the central hole in the first pattern aligns with the central hole in the second pattern;
the second sheet is disposed between the first pattern and the second pattern; and
the first flow holes that are operably connected to the central hole in the first pattern do not align with the first flow holes that are operably connected to the central hole in the second pattern, thereby defining a first flow path and a second flow path that are independent from each other.

In certain embodiments, the invention relates to a method of using any of the devices described herein, comprising the step of introducing into the first flow path a fluid.

### BRIEF DESCRIPTION OF THE DRAWINGS

FIG. 1 is a series of photographs showing the stepwise interlocking co-folding process that transforms two functional strips or sheets into an engineered tissue device. Steps 1-6 illustrate the repeated, two-direction, orthogonal, back-and-forth folding used to create the device architecture. In some embodiments, the folding alternates evenly between vertical and horizontal folding, as shown here, or it may alternate unevenly between the two fold directions.

FIG. 2 is a series of photographs showing the stepwise interlocking co-folding process that transforms three strips into an engineered tissue device. Three strips of paper are oriented at 60 degree angles to each other and co-folded orthogonal to the sheets' lengths to produce a non-rectilinear folded, layered pattern.

FIG. 3 is a photograph showing one strip of paper folded at 60 degree angles to create a system with hexagonal symmetry.

FIG. 4 is a photograph of a polyimide strip that has been laser cut to define flow channels (or, “central holes,” the large circles), out of plane flow routing (or, “flow holes,” the small circles), and in-plane flow routing (the lines that connect (or, “operably connect”) the small circles to the large circles).

FIG. 5 is a schematic diagram of how the patterned polyimide strip can be co-folded in perpendicular orientation with a nanoporous membrane (squares with four small holes near the corners). The direction of the folding is similar to in FIG. 1, but the alternation between fold directions is irregular in this structure.

FIG. 6 is a schematic diagram of the folding pattern that defines one embodiment of a folded unit of engineered liver tissue.

FIG. 7A is a cross-sectional cutaway of an engineered liver tissue unit.

FIG. 7B is a 3D view of an engineered liver tissue unit.

FIG. 7C is a schematic diagram showing the flow pattern of an engineered liver tissue unit. The small circular holes in the bottom left and upper right corners indicate connections to the set of alternating channels that mimic the sinusoids. The channels in the upper left and bottom right corners represent connections to the set of alternating channels that mimic the hepatocyte sheets of a native liver lobule. Communication between the “sinusoids” and the “hepatocyte sheets” is purely diffusive and occurs across nanoporous membranes (not shown in FIG. 7C, but represented by bright horizontal lines in FIG. 7A and FIG. 7B).

### DETAILED DESCRIPTION

### Overview

In certain embodiments, the invention relates to a multi-material, multi-functional microfluidic device comprising a folded architecture that mimics the layered arrangement of cells in certain tissues. In certain embodiments, the device is suitable for tissue engineering (for example, for drug screening or implants), biological sensing, or diagnostics. In certain embodiments, the invention relates to a method of making any of the devices described herein without the use of alignment tooling. Because a single process integrates multiple materials, process compatibility is not a constraint.

In certain embodiments, the invention relates to any of the devices described herein, wherein the device comprises at least two planar sheets, wherein the first sheet and the second sheet are folded in an interlocking pattern, thereby forming a stack of co-folded layers. In certain embodiments, the first sheet and the second sheet comprise different materials. In certain embodiments, the first sheet and the second sheet comprise the same materials. In certain embodiments, the devices enable different biological functions (e.g. flow and diffusion) because of their interlocked folded architecture. In part, “interlocked” means that the sheets are co-folded in a regularly or irregularly alternating pattern. “Interlocked” also means that the sheets are folded from different directions. For example, the two sheets may be patterned into strips that are oriented 90 degrees apart and are folded alternately with each other to produce a multi-material stack.

In certain embodiments, the invention relates to any of the devices described herein, wherein the device has multiple functions because the co-folded sheets have different structures or compositions.

In certain embodiments, the invention relates to any of the devices described herein, wherein the folded architecture results in alignment of structures or features in the first sheet or the second sheet. In certain embodiments, a layer can constrain folding of subsequent layers. As used herein, the term “align” is intended to include “substantially align.” In other words, if a portion of the structure or feature aligns or overlaps with a portion of another structure or feature, such that the function of those structures or features is relatively unaltered (e.g., flow still occurs), the structures or features are aligned. However, when structures or features “do not align” with each other, there is 0% overlap of these structures or features in the device.

In certain embodiments, the invention relates to any of the devices described herein, wherein the first sheet or the second sheet, or both, is cut; patterned; imbued with absorbed materials, coatings, or other functional inclusions; or have inherent material or structural properties that make it so that each layer in the co-folded stack imparts its own function or functions to the full stack. In certain embodiments, the first sheet or the second sheet comprises a pre-patterned “origami crease” in order to ensure proper folding and alignment without the use of an alignment tool.

In certain embodiments, the invention relates to any of the devices described herein, wherein the first sheet or the second sheet, or both, comprises an adhesive. In certain embodiments, the adhesive adheres the first sheet and the second sheet, ensuring that the co-folded layers remain in place after the folding is complete and preventing leakage.

In certain embodiments, the invention relates to any of the devices described herein, wherein the first sheet or the second sheet, or both, is biodegradable, for example, for implantable tissues.

In certain embodiments, the invention relates to any of the devices described herein, wherein the first sheet or the second sheet, or both, is not biodegradable (i.e., is stable), for example, for external use (e.g. drug screening).

In certain embodiments, the invention relates to any of the devices described herein, wherein the first sheet comprises polyimide or polydimethylsiloxane (PDMS). In certain embodiments, the first sheet is substantially impermeable to water.

In certain embodiments, the invention relates to any of the devices described herein, wherein the second sheet is nanoporous. In certain embodiments, the invention relates to any of the devices described herein, wherein the second sheet is a nanoporous membrane. Inclusion of a co-folded nanoporous membrane creates interfaces through which diffusion will occur but flow will not. The surface area of the membrane exposed to the central holes can vary, e.g., depending on the physiological ratio of the surface area to the volume of the tissue to be modeled, volume of the microchannels, cell analysis and/or detection methods, and any combinations thereof. A proper ratio of the surface area of the membrane exposed to the central holes to the volume of the central holes can ensure that the device can function more like an in vivo tissue, which can in turn allow for in vitro results to be extrapolated to an in vivo system. In accordance with some embodiments of the invention, the surface area of the membrane exposed to the central holes can be configured to satisfy the physiological ratio(s) of the surface area to the volume of a tissue to be modeled.

In certain embodiments, the invention relates to any of the devices described herein, wherein the membrane can have any thickness provided that the selected thickness does not significantly affect the flexibility of the membrane or cell behavior and/or response. In accordance with some embodiments of the invention, the thickness of the membrane can range between 70 nanometers and 100 microns, or between 1 micron and 100 microns, or between 10 and 100 microns. In one embodiment, the thickness of the membrane can range between 10 microns and 50 microns. In some embodiments, the thickness of the membrane can range between 100 nm to about 10 microns. While the membrane generally has a uniform thickness across the entire length or width, in accordance with some embodiments of the invention, the membrane can be designed to include regions which have lesser or greater thicknesses than other regions in the membrane. The decreased thickness area(s) can run along the entire length or width of the membrane or can alternatively be located at only certain locations of the membrane. The decreased thickness area can be present along the bottom surface of the membrane, or additionally/alternatively be on the opposing surface of the membrane. It should also be noted that at least portions of the membrane can have one or more larger thickness areas relative to the rest of the membrane, and capable of having the same alternatives as the decreased thickness areas described above.

In certain embodiments, the invention relates to any of the devices described herein, wherein the second sheet comprises polycarbonate.

In certain embodiments, the invention relates to any of the devices described herein, wherein the second sheet comprises collagen.

In certain embodiments, the invention relates to any of the devices described herein, wherein the device further comprises a clamp. In certain embodiments, the clamp ensures that the co-folded layers remain in place after the folding is complete and prevents leakage.

In certain embodiments, the invention relates to any of the devices described herein, wherein adjacent layers are covalently bonded to each other.

In certain embodiments, the invention relates to any of the devices described herein, wherein the device further comprises an adhesive or other bonding interlayer oriented between co-folded layers of first sheet and second sheet.

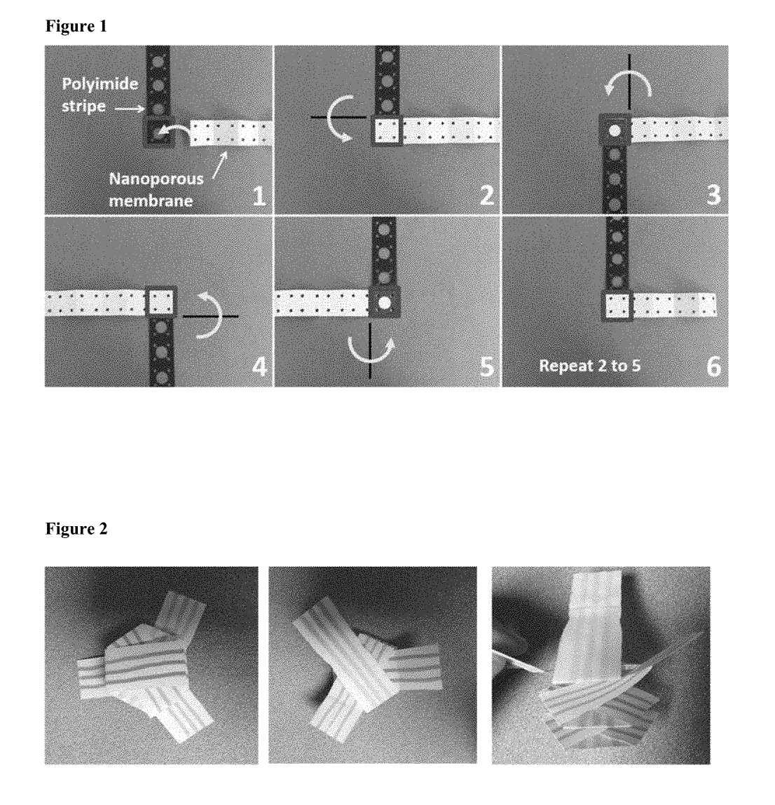

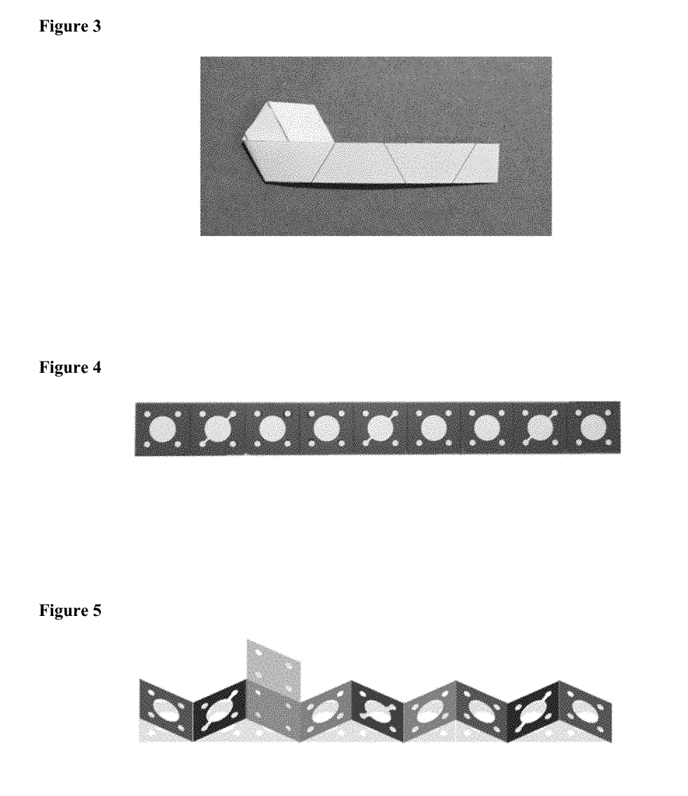

In certain embodiments, the invention relates to any of the devices described herein, wherein the device comprises an interlocked folded architecture. FIGS. 1-3 illustrate three exemplary interlocked folding patterns that may be used to create co-folded stacks. The creation of a device from this pattern also requires that the first sheet or the second sheet comprises a pattern or material that imparts function. In FIG. 1, two flat sheets are patterned into strips that are oriented 90 degrees apart and are folded alternately with each other as shown. In FIG. 2, two or three strips that are oriented at 60 degree angles to each other and co-folded orthogonal to the sheets' lengths to produce non-rectilinear folded, layered patterns; the function of the device will typically reside in the center of the stack, where the layers overlap. In FIG. 3, a sheet (or more than one sheet) is folded in non-orthogonal directions to create a system with triangular or hexagonal symmetry. In certain embodiments, other folds are used, for example, a basic accordion fold. In certain embodiments, where structural stability of the device is important, the sheet is not folded using an accordion fold because folding of a single strip does not offer the same stability as, for example, when two sheets are co-folded, thereby constraining each other's non-ideal motion (e.g., FIG. 1). In certain embodiments, other fold patterns may also be created that capture additional symmetries, fold different numbers of strips, fold at different angles (e.g. 45 degrees), or even weave the strips above and below each other as in a “box gimp” weaving pattern. In certain embodiments, hexagonal panels may also be folded at alternating 60 degree angles to produce an overlapping stack.

In certain embodiments, the invention relates to any of the devices described herein, wherein selected regions of the first sheet are laser-cut, water-jet cut, punched out, hand cut, etched, molded in elastomers or other polymers, or in other ways removed from the first sheet.

In certain embodiments, the invention relates to any of the devices described herein, wherein the first sheet comprises a pattern defining preferential locations for folding. For example, laser-cutting may be used to pattern crease locations. The inclusion of pre-defined crease locations is optional but not required.

In certain embodiments, the invention relates to any of the devices described herein, wherein the device further comprises a sensor. For example, a sensor may be a small electronic chip that measures a quantity of interest (e.g. resistivity of the neighboring fluid). Such a sensor may be laminated onto an adhesive-coated sheet and folded into the stack. Alternatively, sensors may be incorporated by other means, such as by coating binding agents onto a sheet to identify the presence of certain species inside the device.

In certain embodiments, the invention relates to any of the devices or methods described herein, further comprising a first cell or a plurality of first cells (i.e., a first cell population) in the space defined by the first region or first fluid flow path. In certain embodiments, the invention relates to any of the devices or methods described herein, further comprising a second cell or a plurality of second cells (i.e., a second cell population) in the space defined by the second region or second fluid flow path. Cells may be seeded in the device using cell seeding techniques similar to those used in other microfluidic and tissue culture systems. For example, cells in a carrier liquid of cell culture medium may be flowed into the device and permitted to attach to device walls that are suitably coated and prepared for their attachment. Alternatively, the cells may be seeded first, and the stack may then be folded.

To seed cells into the device, a portion of the second sheet (or membrane) can be treated by coating at least one surface with one or more cell adhesion agents (e.g., extracellular matrix molecules comprising glycoproteins, collagen, fibronectin, laminin, vitronectin, elastins, fibrin, proteoglycans, heparin sulfate, chondroitin sulfate, keratan sulfate, hyaluronic acid, or any combinations thereof). In accordance with some embodiments of the invention, no treatment is needed. A first fluid containing a first desired cell population can flow into the first inlet, travel into the first central hole and exit through the first outlet. Optionally and independently, the second fluid containing a second desired cell population can flow into the second inlet, travel into the second central hole and exit through the second outlet. In an alternative embodiment, the inlets and outlets can be switched. In accordance with embodiments of the invention, a first cell population can be seeded on the top surface of the membrane, while optionally a second cell population can be seeded on the bottom surface of the membrane.

Once cells are seeded into the device, fluids containing the necessary nutrients (e.g., oxygen) and growth factors can flow through the central holes. In accordance with some embodiments of the invention, the membrane comprises a plurality of pores or apertures therethrough, whereby molecules, fluid or any media is capable of passing through the membrane via one or more pores in the membrane. Exogenous agents (e.g., drugs) can be introduced to the central holes to evaluate cellular responses.

Described herein are devices comprising co-folded stacks that mimic layered biological tissue. Each device may include multiple layers or multiple flow spaces and channels. It is also possible to combine multiple devices together into a single, multi-device architecture. In such an architecture, flow channels similar to the individual-unit flow channels defined here may be used to connect multiple individual devices together to a common set of inlets and outlets for scaled-up operation.

Devices and methods described in U.S. Patent Application Publication No. 2017/0327781 and U.S. Patent Application Publication No. 2015/0240194 are incorporated by reference.

### Definitions

Unless explicitly defined herein, all technical and scientific terms have the same meaning as commonly understood by one of ordinary skill in the arts to which this invention belongs. Where a term is provided in the singular, the inventor also contemplates the plural of that term.

“Microfluidic device,” as used herein, refers to a device, apparatus or system including at least one fluid-flow path having a dimension (e.g., height, length or depth) of less than 10 or 5 millimeters (mm). Generally the fluid-flow path will have a width of less than 1 mm.

“Fluid-flow path,” “fluid path” or “flow path” as used herein, refer to any channel, tube, region, space or pathway or portion thereof through which a fluid, including a liquid or a gas, may pass. A “fluid flow passageway” includes a portion of a fluid-flow path. Each fluid-flow path may be operably connected to a fluid inlet and a fluid outlet. Fluid inlets are holes, channels or other means for a fluid such as cell culture media to be conducted from outside the device into the fluid-flow path. Fluid outlets are also holes, channels or other means for a fluid such as conditioned or waste cell culture media to be conducted away from the device.

The fluid-flow paths can be varied in any dimension (e.g., length, width or depth) so as to produce a desired flow resistance. For example, the flow rate through a flow path can be regulated as a function of the hydrostatic pressure gradient across an inlet and an outlet. One or more fluid-flow paths may function as a resistance channel, meaning that the fluid-flow path has increased resistance to a fluid flow, either continuous or discontinuous (pulsatile) in nature. Resistance channels may contain, for example, tortuous curves or other geometric forms that increase fluid resistivity.

### Exemplification

The invention, having been generally described, may be more readily understood by reference to the following examples, which are included merely for purposes of illustration of certain aspects and embodiments of the present invention, and are not intended to limit the invention in any way. All headings are for the convenience of the reader and should not be used to limit the meaning of the text that follows the heading, unless so specified.

### Example 1—Artificial Liver Tissue

The first sheet is double-sided polyimide tape that has been patterned to define flow channels (which are similar in function to liver sinusoids). The polyimide tape includes a double-sided acrylic adhesive that is also patterned. UV laser-cutting is a suitable technique for patterning this material. FIG. 4 shows a photograph of a polyimide strip that has been laser cut to define flow channels (the large circles), out of plane flow routing (the small circles), and in-plane flow routing (the lines that connect the small circles to the large circles).

The second sheet is a polycarbonate nanoporous membrane (which permits diffusion similar to the diffusion across the fenestrated endothelium and the Space of Disse in a native liver lobule). In this embodiment, the nanoporous membrane may be pre-patterned with through-holes that permit access to the flow channels, or the through holes may be defined after the system is folded for enhanced self-alignment.

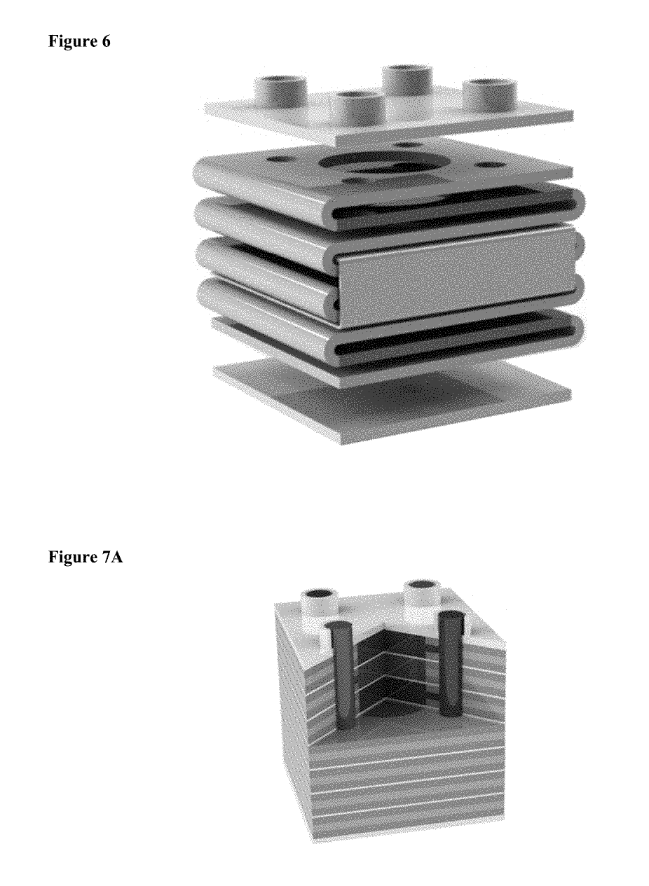

FIG. 5 shows a schematic diagram of how the patterned polyimide strip (horizontal) can be co-folded in perpendicular orientation with a nanoporous membrane (vertical). Note that the patterns do not need to be circles, and other patterns may be chosen to optimize the device's function.

In this example, the layers are oriented at 90 degrees from each other with alternating or irregularly alternating folds that are perpendicular to the layers' lengths. In this particular embodiment, the co-folding of the two layers produces a folded, engineered tissue architecture like the one shown schematically in FIG. 6. The figure also shows packaging plates that may optionally be adhered to the stack to enable fluidic connections (top and bottom).

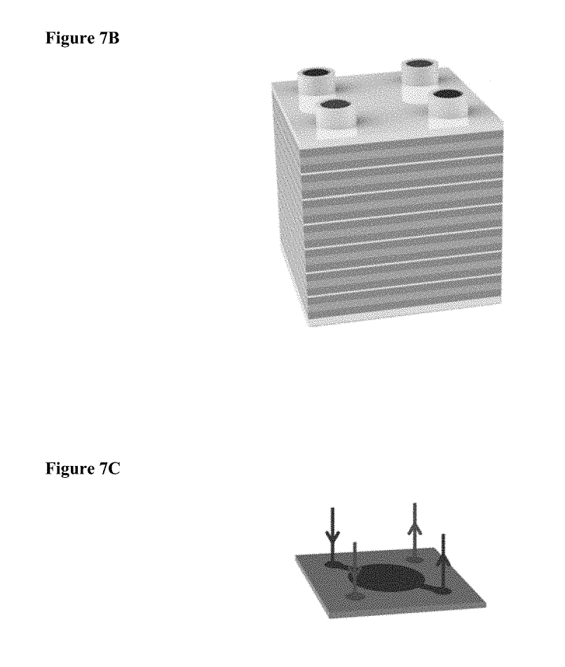

The inner structure and function of this folded tissue architecture are illustrated in FIG. 7A-FIG. 7C. FIG. 7A shows a cross-sectional cut-away of the system. FIG. 7B shows the device without the cut-away. Finally, FIG. 7C shows how the flow passes through a single folded layer. The central circular holes in the figures, which are patterned in the polyimide strip, each form a disk-shaped space that is filled with cell culture media during operation of the engineered tissue device. Each disk-shaped space is separated from its neighbors above and below by a layer of nanoporous membrane. The nanoporous membrane ensures that each disk-shaped space can communicate with its neighbors by diffusion. The smaller holes at the corners are laid out to ensure that every other channel is connected together and to a common inlet and outlet at the device's upper surface. For example, the channels shown in opposite corners are all connected to each other by direct flow connections. The channels shown in adjacent corners are not connected to each other by any direct flow connections; their connection is only via diffusion through the nanoporous membrane. The structure shown with circular holes and straight inlet channels is only an illustrative example; the shapes may have a different shape to tailor the flow pattern.

When combined with inlets and outlets that are patterned into the stack, this architecture defines an alternating set of spaces in which either hepatocytes or endothelial cells can be seeded. The spaces seeded with hepatocytes mimic the hepatocyte layers in native liver lobules. The spaces seeded with endothelial cells mimic the sinusoids in native liver lobules. These spaces are separated by nanoporous membrane layers so that the two cell types may communicate by diffusion. The patterning of the individual layers produces a set of inlet channels that separately access the “hepatocyte” and “sinusoid” spaces. As in native liver lobules, flow is delivered only to the endothelial cell-seeded spaces that mimic liver sinusoids. The only means by which nutrients are delivered to and products are removed from the hepatocyte spaces is diffusion through the nanoporous membranes, from the endothelial cell-lined spaces that mimic sinusoids.

### EQUIVALENTS

Those skilled in the art will recognize, or be able to ascertain using no more than routine experimentation, many equivalents to the specific embodiments of the invention described herein. While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations. Such equivalents are intended to be encompassed by the following claims.

We claim:

1. A device comprising a first sheet and a second sheet folded in an interlocking pattern, thereby forming a stack of co-folded layers; wherein
the second sheet is nanoporous;
the first sheet comprises
a first pattern of first holes comprising a central hole and four first flow holes, wherein at least two of the first flow holes are operably connected to the central hole, and
a second pattern of first holes comprising a central hole and four first flow holes, wherein at least two of the first flow holes are operably connected to the central hole,
the second sheet comprises a repeating pattern of four second flow holes;
the four first flow holes in the first pattern align with the four first flow holes in the second pattern, and the four first flow holes in the first pattern and in the second pattern align with the four second flow holes;
the central hole in the first pattern aligns with the central hole in the second pattern;
the second sheet is disposed between the first pattern and the second pattern; and
the first flow holes that are operably connected to the central hole in the first pattern do not align with the first flow holes that are operably connected to the central hole in the second pattern, thereby defining a first flow path and a second flow path that are independent from each other.

2. The device of claim 1, wherein the first sheet and the second sheet are oriented 90 degrees apart and are folded alternately with each other.

3. The device of claim 1, wherein the first sheet comprises polyimide or polydimethylsiloxane (PDMS).

4. The device of claim 1, wherein the second sheet comprises polycarbonate.

5. The device of claim 1, wherein the first sheet is coated with an adhesive.

6. The device of claim 1, further comprising a clamp; and the clamp holds the co-folded layers in proper relative alignment.

7. The device of claim 1, wherein adjacent layers are covalently bonded to each other.

8. The device of claim 1, further comprising a third sheet.

9. The device of claim 8, wherein the third sheet is co-folded into the interlocking pattern with the first sheet and the second sheet.

10. The device of claim 8, wherein the third sheet is an adhesive sheet disposed between the first sheet and the second sheet.

11. The device of claim 1, wherein the first sheet further comprises a scoring pattern, thereby defining preferential locations for folding.

12. The device of claim 1, wherein the second sheet further comprises a scoring pattern, thereby defining preferential locations for folding.

13. The device of claim 1, further comprising a sensor.

14. The device of claim 1, further comprising a first inlet and a first outlet, wherein the first inlet and the first outlet are operably connected to the first flow path.

15. The device of claim 1, further comprising a second inlet and a second outlet, wherein the second inlet and the second outlet are operably connected to the second flow path.

16. The device of claim 1, further comprising a plurality of first cells in the first flow path.

17. The device of claim 16, wherein the first cells are hepatocytes.

18. The device of claim 1, further comprising a plurality of second cells in the second flow path.

19. The device of claim 18, wherein the second cells are endothelial cells.

20. A method of making a device comprising a first sheet and a second sheet, comprising the step of:
folding in an interlocking pattern the first sheet and the second sheet, thereby forming a stack of co-folded layers,
wherein
the second sheet is nanoporous;
the first sheet comprises
a first pattern of first holes comprising a central hole and four first flow holes, wherein at least two of the first flow holes are operably connected to the central hole, and
a second pattern of first holes comprising a central hole and four first flow holes, wherein at least two of the first flow holes are operably connected to the central hole,
the second sheet comprises a repeating pattern of four second flow holes;
the four first flow holes in the first pattern align with the four first flow holes in the second pattern, and the four first flow holes in the first pattern and in the second pattern align with the four second flow holes;
the central hole in the first pattern aligns with the central hole in the second pattern;
the second sheet is disposed between the first pattern and the second pattern; and
the first flow holes that are operably connected to the central hole in the first pattern do not align with the first flow holes that are operably connected to the central hole in the second pattern, thereby defining a first flow path and a second flow path that are independent from each other.

21. A method of using the device of claim 1, comprising the step of introducing into the first flow path a fluid.
